(19) United States
(12) Patent Application Publication
(10) Pub. No.: US 2006/0056543 A1
(43) Pub. Date: Mar. 16, 2006

(54) Radio pre-recording apparatus and its method

(75) Inventor: Yung-Sheng Hsiao, Taipei (TW)

Correspondence Address: TROXELL LAW OFFICE PLLC, SUITE 1404, 5205 LEESBURG PIKE, FALLS CHURCH, VA, 22041, US

(73) Assignee: Ali Corporation

(21) Appl. No.: 10/979,238

(22) Filed: Nov. 3, 2004

(30) Foreign Application Priority Data
Sep. 14, 2004 (TW) 93127769

(51) Int. Cl. H04L 27/22

(52) U.S. Cl. 375/316

(57) ABSTRACT

A radio pre-recording apparatus and its method is proposed. In the prior art, the important portion of the radio program is usually truncated partially during recording because the recording button isn't pressed in time. For solving this problem, the radio pre-recording apparatus of the present invention has a radio frequency (RF) receiving unit; an analog/digital (A/D) converter; a buffer unit; a digital/analog (D/A) converter; a storage unit; and a control unit. The radio pre-recording method is provided for the apparatus mentioned above to prevent the important portion of the radio program from being partially truncated and to completely record the radio program.

### BACKGROUND OF THE INVENTION

1. Field of the Invention

The present invention is related to a radio pre-recording apparatus and its method, and more particularly, to an apparatus or method that can be used to pre-record a radio program.

2. Description of Related Art

In consumer electronic products, recording radio programs is an important function. However, present recorders can only recode after a recording button is pressed or if they are set to record at a predetermined time. As such, the important portion of the radio program is usually partially truncated during recording because the recording button isn't pressed in time.

Reference is made to FIG. 1, which is a block diagram of a conventional radio recording apparatus. It includes a radio frequency (RF) receiving unit 10 electrically connected to an antenna to receive electromagnetic waves and transform them into analog signals; a recording unit electrically connected to the RF receiving unit 10 to convert the analog signals to digital data and store the digital data into a storage unit 14; a control unit 16 electrically connected to the RF receiving unit and the recording unit 12 to confirm the frequency and reception of the RF receiving unit 10 and record after the recording button is pressed.

Accordingly, as discussed above, the prior art has some drawbacks that can be improved upon. The present invention aims to resolve the drawbacks in the prior art.

### SUMMARY OF THE INVENTION

An objective of the present invention is to provide a radio pre-recording apparatus and its method that can be used to pre-record a radio program. Using the present invention prevents the important portion of the radio program from being partially truncated and completely records the radio program.

For attaining the objective above, the present invention provides an apparatus for pre-recoding a radio program. It includes: a radio frequency (RF) receiving unit to receive radio analog signals; an analog/digital (A/D) converter electrically connected to the RF receiving unit to convert the radio analog signals into digital data; a buffer unit electrically connected to the A/D converter to store the digital data; a digital/analog (D/A) converter electrically connected to the buffer unit to convert the digital data to recover the analog signals; a storage unit electrically connected to the D/A converter to store the analog signals; and a control unit electrically connected to the RF receiving unit and the storage unit to confirm a frequency of the RF receiving unit and receive a start signal for recording.

Moreover, for reaching the above objective, the present invention also provides a method for using the apparatus mentioned above.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional radio recording apparatus;

FIG. 2 is a block diagram of a radio pre-recording apparatus in accordance with the present invention;

FIG. 3 is a table for illustrating the memory arrangement of the buffer unit in accordance with a radio pre-recording method of the present invention; and

FIG. 4 is a flowchart of the radio pre-recording method in accordance with the present invention.

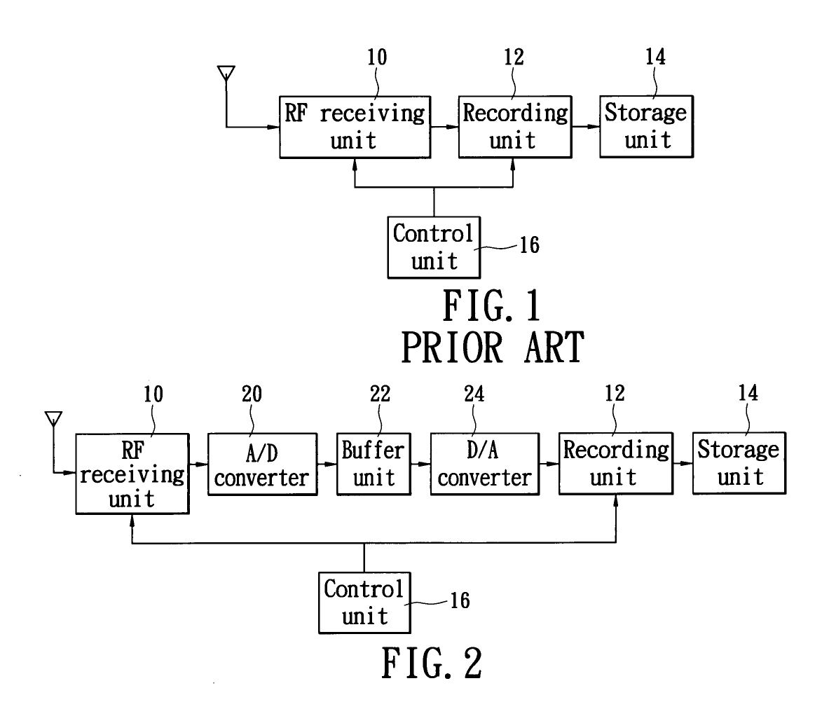

### DETAILED DESCRIPTION OF PREFERRED EMBODIMENTS

The present invention provides a radio pre-recording apparatus that can record a radio program in a buffer unit. Thereby, the present invention can pre-record the radio program for several seconds before the recording button is pressed. This function is very useful for consumers.

Reference is made to FIG. 2, which is a block diagram of a radio pre-recording apparatus in accordance with the present invention. It includes a RF receiving unit 10 to receive radio analog signals, an analog/digital (A/D) converter 20 electrically connected to the RF receiving unit 10 to convert the radio analog signals to digital data, a buffer unit 22 electrically connected to the A/D converter 20 to store the digital data. The buffer unit 22 can be a static random access memory (SRAM), a dynamic random access memory (DRAM), a double data random access memory (DDRAM) or a flash memory.

The present invention also includes a digital/analog (D/A) converter 24 electrically connected to the buffer unit 22 to convert the digital data to analog signals, a recording unit 12 electrically connected to the D/A converter 24 to record the analog signals, a storage unit 14 electrically connected to the D/A converter 24 to store the analog signals, wherein the storage unit 14 can be a hard disc, a flash disc or a recordable digital versatile disc (DVD); and a control unit 16 electrically connected to the RF receiving unit 10 and the recording unit 12 to confirm the frequency of the RF receiving unit 10 and receive a start signal for recording.

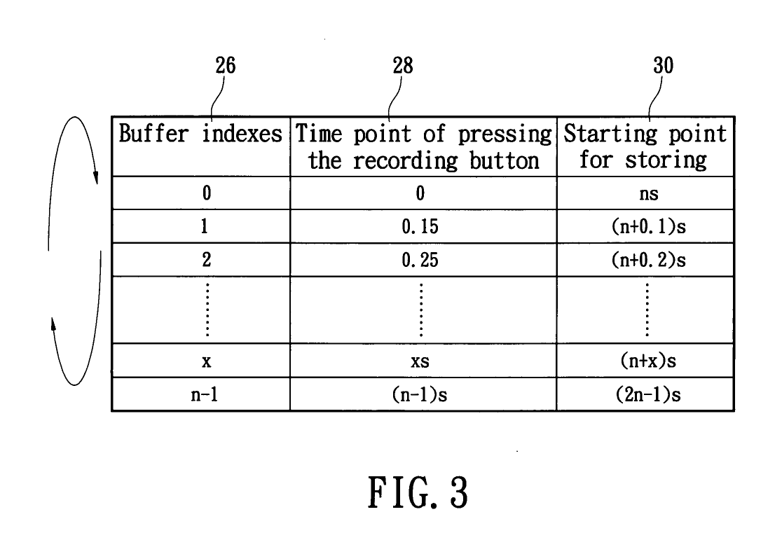

Reference is made to FIG. 3, which is a table for illustrating the memory arrangement of the buffer unit in accordance with a radio pre-recording method of the present invention. The table includes buffer indexes 26, time point of pressing the recording button 28 and starting time for storing 30. If the recording button is pressed at 0.1s, the present invention stores the digital data recorded from (n+0.1)s to the storage unit; and if the recording button is pressed at (n−1)s, the present invention stores the digital data recorded from (2n−1)s. Therein, the digital data recorded during (n+0.1)s is recorded in the memory corresponding to an index 1 of the buffer; and the digital data recorded during (2n−1)s is recorded in the memory corresponding to the index (n−1) of the buffer.

Moreover, the present invention uses a cyclic recording scheme to record the digital data. Initially, the present invention records the digital data orderly to the buffer unit from index 0 to index (n−1). When the memory of the buffer unit runs out, the present invention will overwrite the buffer unit from the index 0 to the index (n−1) repeatedly.

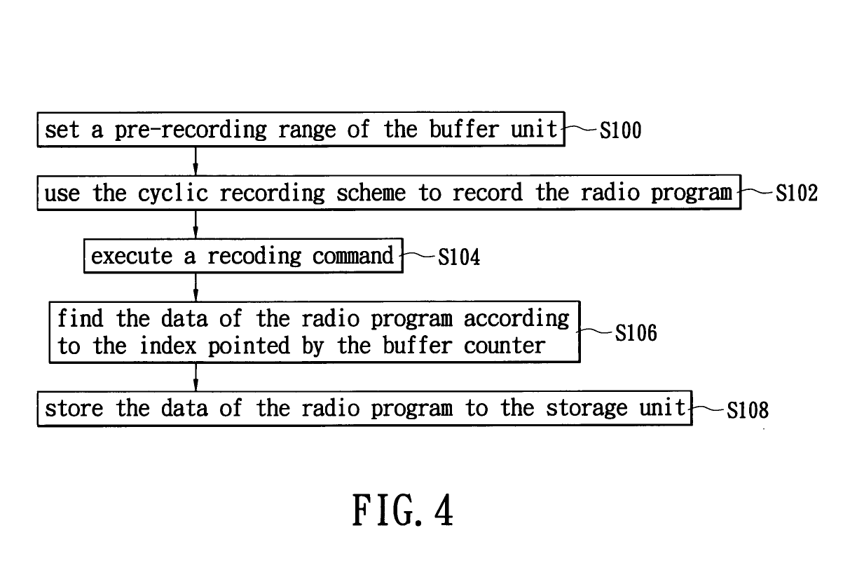

Reference is made to FIG. 4, which is a flowchart of the radio pre-recording method in accordance with the present invention. It includes the following steps: setting a pre-recoding range of the buffer unit (S100), wherein the buffer unit can be a SRAM, a DRAM, a DDRAM or a flash memory and has a buffer counter such as a program counter; using a cyclic recording scheme to record a radio program (S102); executing a recording command (S104), wherein the recording command is issued by pressing a recording button; finding the recorded digital data of the radio program according to the index pointed by the buffer counter and the set pre-recoding range (S106), wherein the index pointed by the buffer counter is changed dynamically and the digital data of the radio program can be the digital data pre-recorded before the recording command is issued; storing the digital data of the radio program to a storage unit (S108), wherein the storage unit is a storing medium such as a hard disc, a flash disc or a recordable DVD.

In practical operation of the present invention, when a user presses the recording button, the radio pre-recording apparatus stores the digital data of a radio program pre-recorded in the buffer unit to the storage unit. The pre-recoding range can be up to 5 seconds. In this way, upon hearing the radio-program, the user can record the important portion of the radio program that they just heard, by pressing the recording button. Even though the important portion has been broadcasted already, it can still be stored in the storage unit if the user presses the recording button within the pre-recording range. That is because the buffer unit of the present invention can pre-record a portion of the radio program before the user presses the recording button.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A method for pre-recoding a radio program, comprising:
setting a pre-recording range of a buffer unit;
using a cyclic recording scheme to record the radio program;
executing a recoding command;
finding data of the radio program recorded in the buffer unit according to an index pointed by a buffer counter of the buffer unit; and
storing the recorded data of the radio program to a predetermined storage unit.

2. The method as claimed in claim 1, wherein the buffer unit is a static random access memory (SRAM), a dynamic random access memory (DRAM), a double data random access memory (DDRAM) or a flash memory.

3. The method as claimed in claim 1, wherein the buffer counter is a program counter.

4. The method as claimed in claim 1, wherein the index pointed by the buffer counter is changed dynamically.

5. The method as claimed in claim 1, wherein the recoding command is issued by pressing a recording button.

6. The method as claimed in claim 1, wherein the data of the radio program is pre-recoded in the buffer unit before the recording command is issued.

7. The method as claimed in claim 1, wherein the storage unit is a storing medium.

8. The method as claimed in claim 7, wherein the storing medium is a hard disc, a flash disc or a recordable digital versatile disc (DVD).

9. An apparatus for pre-recoding a radio program, comprising:
a radio frequency (RF) receiving unit to receive radio analog signals;
an analog/digital (A/D) converter electrically connected to the RF receiving unit to convert the radio analog signals to digital data;
a buffer unit electrically connected to the A/D converter to store the digital data;
a digital/analog (D/A) converter electrically connected to the buffer unit to convert the digital data to recover the analog signals;
a storage unit electrically connected to the D/A converter to store the analog signals; and
a control unit electrically connected to the RF receiving unit and the storage unit to confirm a frequency of the RF receiving unit and receive a start signal for recording.

10. The apparatus as claimed in claim 9, wherein the buffer unit is a SRAM, a DRAM, a DDRAM or a flash memory.

11. The apparatus as claimed in claim 9, wherein the storage unit is a hard disc, a flash disc or a recordable DVD.
